(19) United States
(12) Patent Application Publication
(10) Pub. No.: US 2015/0187248 A1
(43) Pub. Date: Jul. 2, 2015

(54) DISPLAY DEVICE AND DISPLAY METHOD

(71) Applicant: Sharp Kabushiki Kaisha, Osaka (JP)

(72) Inventors: Ken Inada, Osaka (JP); Asahi Yamato, Osaka (JP)

(73) Assignee: SHARP KABUSHIKI KAISHA, Osaka (JP)

(21) Appl. No.: 14/414,859

(22) PCT Filed: Jul. 19, 2013
(86) PCT No.: PCT/JP2013/069601

§ 371 Date: Jan. 14, 2015

(30) Foreign Application Priority Data
Jul. 25, 2012 (JP) 2012-164762

(51) Int. Cl. G09G 3/20; G06T 7/40

(52) U.S. Cl. CPC G09G 3/2003; G06T 7/408; G09G 3/2007; G06F 3/1431

(57) ABSTRACT

In one embodiment, a display device, which is a portable terminal having two screens, refers to matrix parameters in a color correction table storage unit in order to adjust a bluish tint on a liquid crystal touch panel in accordance with input from a user, such as through a settings screen or the like on a screen of a 3D liquid crystal panel. This changes the 3D liquid crystal panel screen to the same bluish tint as the liquid crystal touch panel, thus matching the tint of both liquid crystal panels through simple input, and without requiring both liquid crystal panels to be adjusted separately.

### TECHNICAL FIELD

The present invention relates to a display device and a display method. Specifically, the present invention relates to a display device such as a portable terminal that uses a plurality of display panels, and a display method therefor.

### BACKGROUND ART

Recently, some display devices, such as portable terminals, have been provided with two screens by having two display panels. In portable display devices that allow gaming, in particular, one of the display panels can have a high resolution display or a stereoscopic display, and the other display panel can serve as a touch panel for receiving operation input.

The display panel capable of stereoscopic display has parallax barriers such as shutter elements or film, or lenticular lenses, for example, and the touch panel adopts one of several well-known schemes for identifying a location on the panel that has been touched, such as a resistive scheme, a capacitive scheme, an optical sensor scheme, an infrared scheme, or the like, for example.

The two display panels included with the portable terminal in this manner often have different configurations from each other, and these differences often manifest themselves as differences in tint. Furthermore, variation (individual differences) of display quality is an inherent characteristic of display panels, and thus the respective tints of the two display panels are sometimes markedly different. It is therefore necessary to adjust the tint so as to appear natural to the user.

Japanese Patent Application Laid-Open Publication No. 2006-91237 discloses a display device capable of adjusting tints through image processing that uses a prescribed matrix in order to correct variation in display quality caused by individual differences in illumination devices.

### RELATED ART DOCUMENT

### Patent Document

Patent Document 1: Japanese Patent Application Laid-Open Publication No. 2006-91237

### SUMMARY OF THE INVENTION

### Problems to be Solved by the Invention

If the conventional tint adjusting method of a display device such as described in Japanese Patent Application Laid-Open Publican No. 2006-91237 is applied as-is to a display device (or portable terminal) having two display panels, however, then each screen needs to be adjusted, which costs time and labor. In particular, having the user adjust the tints before using the display device because of passage of time before usage or the like places a burden on the user.

As a countermeasure, the present invention aims at providing a display device with two display panels, such as a portable terminal, that allows for simple adjustment of the tints of the two display panels.

### Means for Solving the Problems

A first aspect of the present invention is a display device capable of displaying images on a first screen and a second screen, including:

a first display panel to display an image thereon in accordance with a first image signal;

a second display panel to display an image thereon in accordance with a second image signal; and

an image adjustment unit that adjusts a tint of the image to be displayed on the first screen by correcting pixel gradation values included in the first image signal such that the tint matches a tint of the image displayed on the second screen.

A second aspect of the present invention is the first aspect of the present invention,

wherein the second display panel is a touch panel that can obtain coordinates from the second screen when adjacent to, in contact with, or pressed by a user.

A third aspect of the present invention is the second aspect of the present invention,

wherein the second display panel is a resistive scheme or a capacitive scheme touch panel.

A fourth aspect of the present invention is the third aspect of the present invention,

wherein the image adjustment unit performs correction to increase blue pixel gradation values among the pixel gradation values included in the first image signal.

A fifth aspect of the present invention is the first aspect of the present invention,

wherein the first display panel is capable of displaying glasses-free stereoscopic images using a parallax barrier scheme or a lenticular lens scheme.

A sixth aspect of the present invention is the first aspect of the present invention,

wherein the first display panel and the second display panel are provided in a position where the first screen and the second screen can be viewed at the same time by a user.

A seventh aspect of the present invention is the first aspect of the present invention,

wherein the image adjustment unit adjusts the tint through matrix conversion.

An eight aspect of the present invention is a method of display for causing images to be displayed on a first screen and a second screen, the method including:

displaying an image on the first screen in accordance with a first image signal;

displaying an image on the second screen in accordance with a second image signal; and

adjusting a tint of the image to be displayed on the first screen by correcting pixel gradation values included in the first image signal such that the tint matches a tint of the image displayed on the second screen.

### Effects of the Invention

According to the first aspect of the present invention, the image adjustment unit adjusts the tint of the image displayed on the first screen in order to match the tint of the image displayed on the second screen by correct pixel gradation values included in the first image signal; therefore, the tints of the first display panel and the second display panel can match each other with ease and without needing to be separately adjusted.

According to the second aspect of the present invention, the second display panel can obtain coordinates on the second screen by being adjacent to, touched, or pressed by the user; thus, the tints of the display panels can match each other with ease, without changing the tint of the touch panel, for which it is relatively difficult to perform gradation correction.

According to the third aspect of the present invention, the second display panel is a touch panel that adopts a resistive scheme or a capacitive scheme; therefore, the present invention can be low-cost and the tints of the display panels can match each other with ease, without changing the tint of the touch panel, for which it is relatively difficult to perform gradation correction.

According to the fourth aspect of the present invention, resistive or capacitive touch panels often have a bluish tint, and thus by correcting the first screen to match this bluish color, the tints of both liquid crystal panels can be matched with ease.

According to the fifth aspect of the present invention, the first display panel is capable of displaying glasses-free stereoscopic images through a parallax barrier scheme or a lenticular lens scheme; therefore, the display can be high resolution and have a high dynamic change, and accurate adjustment of the tints can be performed.

According to the sixth aspect of the present invention, the first display panel and the second display panel are provided in a position where the first screen and the second screen can be viewed at the same time by the user; thus, even if the user does not notice the differences in tint individually, it will be easier to notice these differences when the screens are compared by being viewed in this manner. Therefore, the above configuration increases display quality by matching the tints of the display panels to each other with ease.

According to the seventh aspect of the present invention, tint adjustment is performed through matrix conversion; thus, it is possible to perform complicated conversions with ease.

According to the eighth aspect of the present invention, a method of display can exhibit similar effects to the effects of the first aspect.

### BRIEF DESCRIPTION OF THE DRAWINGS

FIG. 1 is a perspective view of a schematic configuration of a liquid crystal display device according to one embodiment of the present invention.

FIG. 2 is a block diagram of a configuration of the liquid crystal display device according to the above-mentioned embodiment.

FIG. 3 is a block diagram of the complete configuration of a first display device in the above-mentioned embodiment.

FIG. 4 is a schematic view of a configuration of a display unit in the first display device in the above-mentioned embodiment.

FIG. 5 is an equivalent circuit diagram of a pixel formation area P (n, m) in the display unit of the above-mentioned embodiment.

FIG. 6 is a block diagram of a configuration of a display control circuit according to the above-mentioned embodiment.

FIG. 7 is a view of an example of a user interface for the user to give input values.

FIG. 8 is an xy chromaticity diagram for explaining characteristics of the display device of the above-mentioned embodiment.

### DETAILED DESCRIPTION OF EMBODIMENTS

Embodiments of the present invention will be explained below with reference to the drawings.

### 1. COMPLETE STRUCTURE OF LIQUID CRYSTAL DISPLAY DEVICE

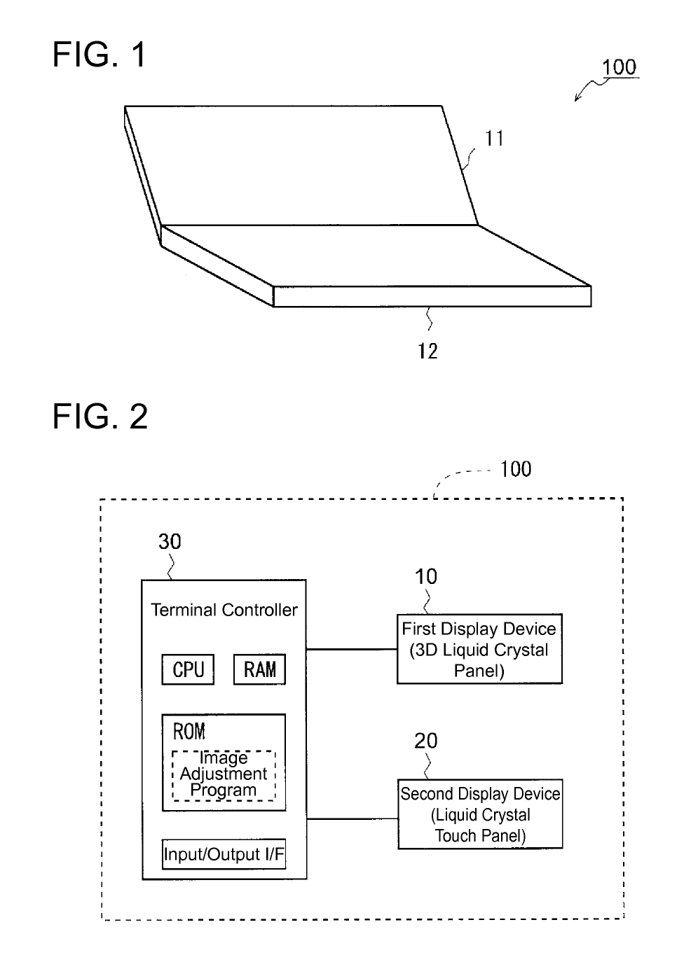

FIG. 1 is a perspective view of a schematic configuration of a liquid crystal display device according to the present embodiment. This display device 100 is a portable terminal with two screens and can perform high resolution (i.e., high number of pixels) and high dynamic range (i.e., high number of display gradients) display. The display device 100 includes a 3D liquid crystal panel 11 (hereinafter, also referred to as “liquid crystal panel 11”) provided with parallax barriers that enable glasses-free stereoscopic viewing, and a liquid crystal touch panel 12 (hereinafter, also referred to as “liquid crystal panel 12”) having a low resolution and low gradient display capable of coordinate input through fingers or the like.

As shown in FIG. 1, the edges of the liquid crystal panel 11 and the liquid crystal panel 12 are adjacent to each other and connected by a mobility mechanism (not shown), such as a hinge, so that the relative angles of the display surfaces to each other can be changed. This type of mobility mechanism is merely an example and may be omitted. The liquid crystal panel 11 and the liquid crystal panel 12 may have the positions thereof secured such that the display screens are on the same plane, for example. As described later, however, comparison of the two display screens will cause the user to recognize a difference in the tints thereof, and thus it is necessary for these display screens to be in a positional relationship that allows for easy viewing. Accordingly, when providing the respective display screens on the front and rear of a terminal device, the difference in tint will not be recognized, which cannot be said to be a suitable configuration for applying the present invention.

FIG. 2 is a block diagram of the complete configuration of the liquid crystal display device. The display device 100 shown in FIG. 2 includes a first display device 10, which is the 3D liquid crystal display panel 11 (hereinafter, also referred to as “3D liquid crystal panel 10”), a second display device 20, which is the liquid crystal touch panel 12 (hereinafter, also referred to as “liquid crystal touch panel 20”), and a terminal controller 30.

The terminal controller 30 is an ordinary control computer and includes a CPU, RAM, ROM, input/output interface, and the like. Tint adjustment, which is one characteristic of the present invention, is performed inside the ROM; thus, if providing the user with a user interface for adjustment, the image adjustment program for this purpose is stored inside the ROM.

This terminal controller 30 also outputs image signals to the first and second display devices 10 and 20. If the display device 100 is a portable gaming terminal, for example, an image signal indicating a gaming screen that is generated on the basis of the gaming program stored in the ROM is generated and sent to the first and second display devices 10 and 20. The contents of this image signal may be of any type, but it is preferable that the contents be a color image that allows for a difference in tints to be recognized on the two screens. The image is not limited to a color image, because even with an image signal indicating a gray image, difference in gradation that is equivalent to the difference in tints can be recognized.

The liquid crystal touch panel 12 does not need to be a low resolution and low gradient display in particular, but due to costs and the like, it is common to use a low resolution and low gradient display that is sufficient for displaying the input/output interface. It is also not necessary for the 3D liquid crystal panel 11 to be a high resolution and high gradient display in particular, but it is common for a high quality display to be demanded for gaming screens and the like, for example; therefore, high resolution and high gradient display panels are often used for these displays.

Accordingly, tint adjustment of the 3D liquid crystal panel 11 can be minutely configured, in general, and it is common for the tint to be adjusted to an ideal tint in advance. In contrast, there are times when minute tint adjustment of the liquid crystal touch panel 12 is not possible and when the tint thereof deviates from the ideal. It is known that resistive and capacitive liquid crystal touch panels, in particular, often develop more of a bluish tint than ordinary liquid crystal panels. Therefore, the bluish tint is adjusted in advance, which typically resolves the issue, but there are also situations where the tint becomes slightly bluish again due to individual differences in the liquid crystal touch panels, passage of time, and the like.

This type of tint deviation is often not clear to the user at first glance (not immediately recognizable), but even if the difference in tints is not recognizable by merely looking at the liquid crystal touch panel, the user may recognize the tint deviation when comparing the liquid crystal touch panel to a high resolution and high gradient display liquid crystal panel, such as the 3D liquid crystal panel. In other words, it is easy to recognize tint deviation when the user views two screens simultaneously (i.e., at the same time in a position close to the screens), as in the present display device 100. Accordingly, the present display device has a tint adjustment function (as described later) to compensate for these types of tint deviations. Before this function is described, the configurations of the first and second display devices 10 and 20, which are equivalent to the two liquid crystal panels 11 and 12 forming the display device 100, will be explained. The basic configurations of these display devices are approximately the same, and thus the configuration of the first display device 10 will be explained below.

### 2. ENTIRE CONFIGURATION AND OPERATION OF LIQUID CRYSTAL DISPLAY DEVICE

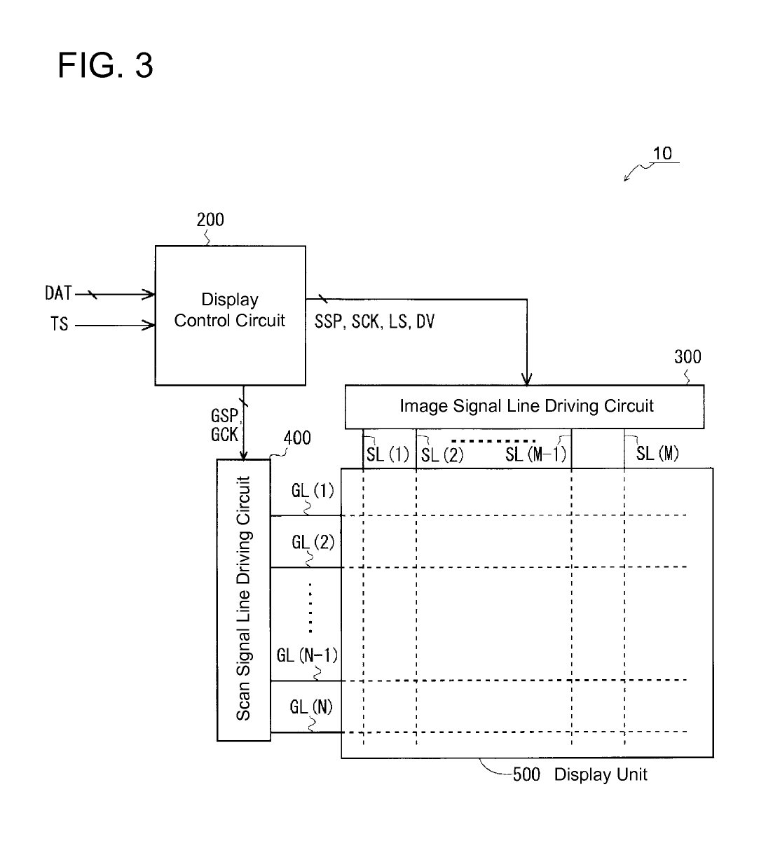

FIG. 3 is a block view of the entire configuration of an active-matrix liquid crystal display device, which is the first display device according to one embodiment of the present invention. This first display device 10 includes a display unit 500, and a driving control unit constituted of a display control circuit 200, an image signal line driving circuit 300, and a scan signal line driving circuit (gate driver) 400.

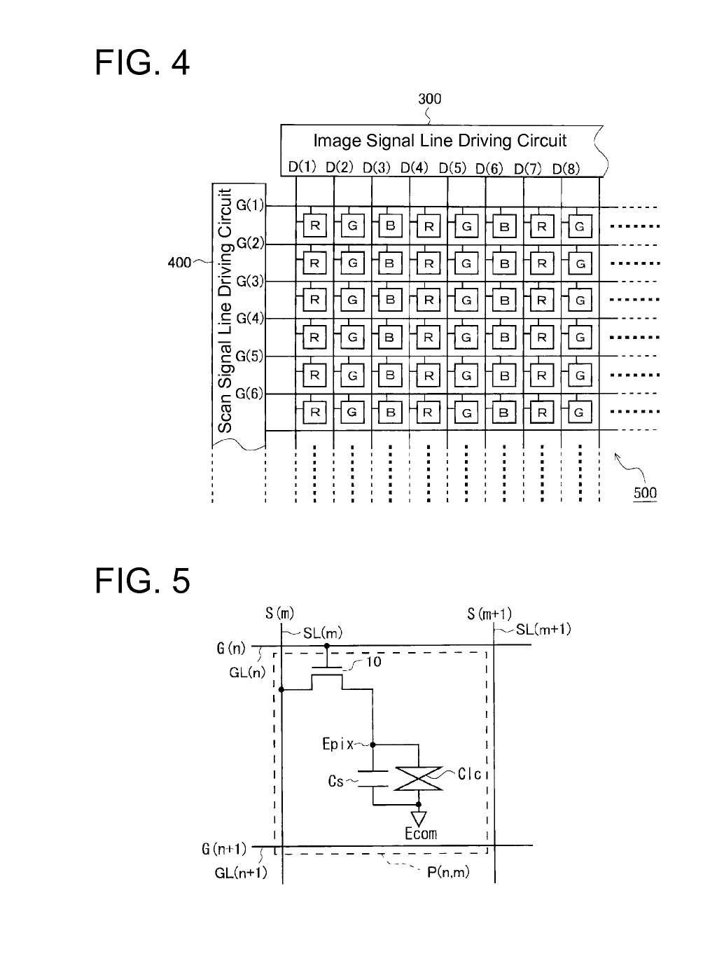

The display unit 500 shown in FIG. 3 has a plurality (M) of image signal lines SL (1) to SL (M), a plurality (N) of scan signal lines GL (1) to GL (N), and a plurality (M×N) of pixel formation areas respectively corresponding to intersections of the plurality of image signal lines SL (1) to SL (M) and the plurality of scan signal lines GL (1) to GL (N) (hereinafter, the pixel formation areas respectively corresponding to the intersections of the scan signal lines GL (n) and image signal lines SL (m) will be shown with reference character “P (n, m)”). The display unit 500 has a configuration such as those shown in FIGS. 4 and 5. FIG. 4 schematically shows a configuration of the display unit 500 in the first display device, and FIG. 5 shows an equivalent circuit of a pixel formation area P (n, m) in this display unit 500.

As shown in FIGS. 4 and 5, each of the pixel formation areas P (n, m) is constituted of: a thin film transistor (TFT; switching element) 10 that has the gate terminal thereof connected to the scan signal line GL (n) passing through the corresponding intersection and the source terminal thereof connected to the image signal line (SL) passing through the same intersection; a pixel electrode Epix connected to the drain terminal of this TFT 10; a common electrode (“opposite electrode”) Ecom that is the counter electrode to the plurality of pixel formation areas P (i, j) (i=1˜N, j=1˜M) described above; and a liquid crystal layer as an electro-optical element sandwiched between the pixel electrode Epix and common electrode Ecom and corresponding to the plurality of pixel formation areas described above P (i, j) (i=1˜N, j=1˜M).

In FIG. 4, the reference characters “R,” “G,” and “B” in the respective pixel formation areas P (n, m) indicate the color displayed by the corresponding pixel formation area P (n, m): “Red,” “Green,” or “Blue,” respectively. Accordingly, each of the RGB pixels of the respective RGB pixel formation areas constitutes a single group that forms a single color pixel.

Although not shown in the drawing, a line inversion driving scheme is adopted whereby a common electrode driving circuit causes the voltage applied to the common electrode to invert, causes the positive or negative polarity of the voltage applied to the pixel liquid crystal to invert for every row in the display unit 500, and also causes inversion for every frame.

As shown in FIG. 5, in each of the pixel formation areas P (n, m), a liquid crystal capacitance C1c is formed by the pixel electrode Epix and the common electrode Ecom that faces the pixel electrode Epix across the liquid crystal layer. An auxiliary capacitance Cs is formed in the vicinity of the liquid crystal capacitance C1c.

The TFT 10 becomes conductive when the scan signal G (n) to be applied to the scan signal line GL (n) becomes active and is selected. Thereafter, a driving image signal S (m) is applied to the pixel electrode Epix via the image signal line SL (m). This causes the voltage of the applied driving image signal S (m) (a voltage with the potential of the common electrode Ecom as reference) to be written to the pixel formation area P (n, m) having this pixel electrode Epix.

The pixel formation area P (n, m) performs display by controlling the transmittance of light from a backlight device (i.e., from a light guide plate 116 thereof); thus, in the present specification, the pixel formation area P (n, m), along with this backlight device, is referred to as the display element.

The display control circuit receives display data signals DAT and timing control signals TS from outside, and outputs digital image signals DV. The display control circuit 200 also outputs source start pulse signals SSP, source clock signals SCK, latch strobe signals LS, gate start pulse signals GSP, and gate clock signals GCK for controlling the timing of image display of the display unit 500. This display control circuit 200 also suitably corrects the received display data signal DAT to compensate for changes in tint, and outputs the result as the digital image signal DV. This operation and specific configuration are explained in detail later.

The image signal line driving circuit 300 receives the digital image signal DV outputted from the display control circuit 200, the source start pulse signal SSP, the source clock signal SCK, and the latch strobe signal LS, and applies the driving image signal to the respective image signal lines SL (1) to SL (M) in order to charge the pixel capacitance of the respective pixel formation areas P (n, m) within the display unit 500. At this time, in the image signal line driving circuit 300, the digital image signals DV indicating the voltage to be applied to the respective image signal lines SL (1) to SL (M) are sequentially held in accordance with the generated pulses of the source clock signals SCK. The held image signals DV are converted to analog voltage in accordance with pulses of the latch strobe signals LS. The converted analog voltage is applied together to all of the image signal lines SL (1) to SL (M) as driving image signals. In other words, in the present embodiment, a line-sequential driving scheme is adopted for the driving of the image signal lines SL (1) to SL (M). The image signals applied to the respective image signal lines SL (1) to SL (M) have the respective polarities thereof inverted in order to drive the display unit 500 with alternating current.

The scan signal line driving circuit 400 sequentially applies active scan signals to the respective scan signal lines GL (1) to GL (N) in accordance with the gate start pulse signals GSP and the gate clock signals GCK outputted from the display control circuit 200.

A common electrode driving circuit (not shown) generates a common voltage Vcom, which is the voltage to be applied to the common electrode of the liquid crystal, and the potential of the common electrode is also changed in accordance with the driving of the alternating current in order to suppress vibration of the voltage of the image signal lines.

As described above, the driving image signals are applied to the respective driving image signals SL (1) to SL (M) and the scan signals are applied to the respective scan signal lines GL (1) to GL (N), thereby controlling transmittance of the liquid crystal layer and displaying an image on the display unit 500.

### 3. CONFIGURATION AND OPERATION OF DISPLAY CONTROL CIRCUIT

<3.1 Configuration and Operation of Entire Display Control Circuit>

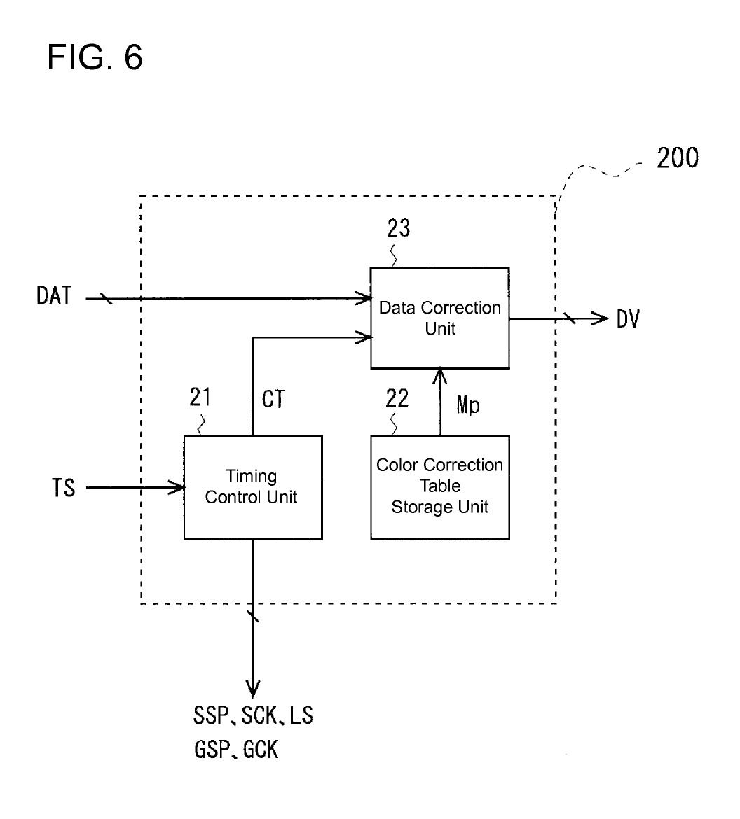

FIG. 6 shows a block view of the entire configuration of the display control circuit of the present embodiment. This display control circuit 200 includes a timing control unit 21 that controls timing, a color correction table storage unit 22 that stores parameters Mp (described later) for adjusting tints, and a data correction unit 23 that receives pixel values (display gradation data) included in the display data signals DAT received from outside the device and corrects the pixel values in accordance with the parameters Mp stored in the color correction table storage unit 22 by performing computations such that the tint of a blue color changes.

First, the timing control unit 21 shown in FIG. 6 receives the timing control signal TS from outside, and outputs a control signal CT for controlling operation of the data correction unit 23, as well as the source start pulse signals SSP, source clock signals SCK, latch strobe signals LS, gate start pulse signals GSP, and gate clock signals GCK for controlling timing of the image to be displayed on the display unit 500.

The color correction table storage unit 22 changes the pixel values (display gradation data) included in the display data signals DAT, which will be given to the data correction unit 23, to corresponding luminance data. Specifically, this luminance data is obtained from the gradation data by referring to a lookup table (LUT) stored in the color correction table storage unit 22. Next, a matrix conversion is performed on the obtained luminance data to change this luminance data into target color data (luminance data). Specifically, 3×3 prescribed parameters (hereinafter, also referred to as “matrix parameters”) stored in the color correction table storage unit 22 are used to perform the above-mentioned color conversion. Finally, the LUT stored in the color correction table storage unit 22 is referred to again in order to obtain corresponding pixel values (display gradation data) from the luminance data obtained in the above-mentioned conversion. Performing matrix conversion with matrix parameters in this manner allows for the complicated conversions described above to be performed with ease.

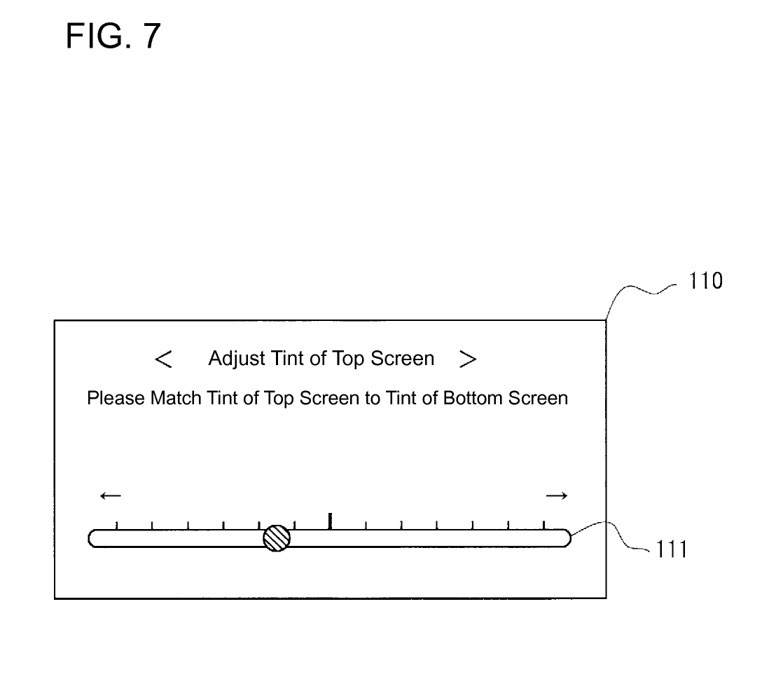

FIG. 7 is a view of an example of a user interface for the user to give input values. An adjustment bar display area 110 shown in FIG. 7 is an area that displays a pop-up window or the like on a portion of the liquid crystal touch panel 20 screen. The adjustment bar display area 110 is displayed by operation input whereby a prescribed button (e.g., a screen adjustment button) on the liquid crystal touch panel 20 is selected, for example.

Instructions that indicate how to match the tint on the top of the screen (the 3D liquid crystal panel 10 screen) to the tint on the bottom of the screen (liquid crystal touch panel 20) are displayed on this adjustment bar display area 110, and an adjustment bar 111 functioning as a slider bar is displayed below this. This adjustment bar 111 has a round portion (the shaded portion in FIG. 7) that can be moved to left and right, and the user can adjust the tint on the screen of the 3D liquid crystal panel 10 by touching this portion with a finger or the like and moving the portion to the left or right. This type of operation is realized by an image adjustment program stored inside the ROM of the terminal controller 30, for example.

The configuration in FIG. 7 allows for the tint of the 3D liquid crystal panel 10 screen to be adjusted so as to turn yellow, but as described above, in general the liquid crystal touch panel 20 becomes a bluish tint. As a countermeasure, matrix parameters (correction values) considered to be suitable can be calculated in advance in accordance with parameters such as passage of time, and then values may be chosen as a median value of the adjustment bar 111 and configured automatically. In this manner, it is also possible for the user to move the slider bar to the right if the user feels the blue color is too strong.

The data correction unit 23 receives pixel data (display gradation data) included in the display data signals DAT received from outside the device and performs a color conversion process whereby the matrix parameters from the color correction table storage unit 22 are applied to change the blue tint.

If the respective pixels of RGB are 8-bit and 256-gradation, for example, then several sets of matrix parameters corresponding to a user-definable correction level (input value) are stored in the color correction table storage unit 22 as a single matrix parameter group that includes 9 values, i.e., 16-bit data, for example. It is preferable that the number of bits constituting the matrix parameters be larger than the number of bits in the gradation data, so that conversion is precise, but the number may also be small.

If all devices have the same correction levels (matrix parameters), then only one matrix parameter Mp is necessary per one input value from the user, but there are situations where the liquid crystal touch panel 20 develops a bluish tint, or where all display devices do not change at the same gradation. Accordingly, this amount of change is estimated (or calculated) in advance, and the corresponding matrix parameter Mp is stored in the color correction table storage unit 22.

There are limits to the storage capacity of storage devices; thus, a plurality of matrix parameters are stored, and the values therebetween are interpolated by a well-known interpolation method such as linear interpolation. Specifically, calculations are done in the data correction unit 23 on the basis of the matrix parameters Mp received from the color correction table storage unit 22. Needless to say, a configuration may be used whereby a single matrix parameter Mp is stored and whereby interpolation calculation is not performed.

One of the reasons that several sets of matrix parameters Mp are necessary is that merely equalizing the values constituting the matrix parameters Mp in accordance with the input values from the user will not allow for accurate correction. In other words, if the liquid crystal touch panel 20 develops a bluish tint, the amount of change is not equal for large changes in tint and small changes in tint, but rather changes at an amount that corresponds to predetermined characteristics for each situation. Accordingly, the characteristics of these changes are estimated (or calculated) in advance in a similar manner, and each matrix parameter Mp corresponding to the respective input values are stored in the color correction table storage unit 22.

In order to reduce storage capacity, a number of matrix parameter Mp sets that are smaller in number than the predetermined input values of the user (half the number, for example) is stored, and then the intermediate values are interpolated by a well-known interpolation method such as linear interpolation, in a manner similar to above. There is a possibility that correction will not be performed accurately, but a configuration may be used whereby a single set of matrix parameters Mp is stored and multiplied in accordance with the input values of the user.

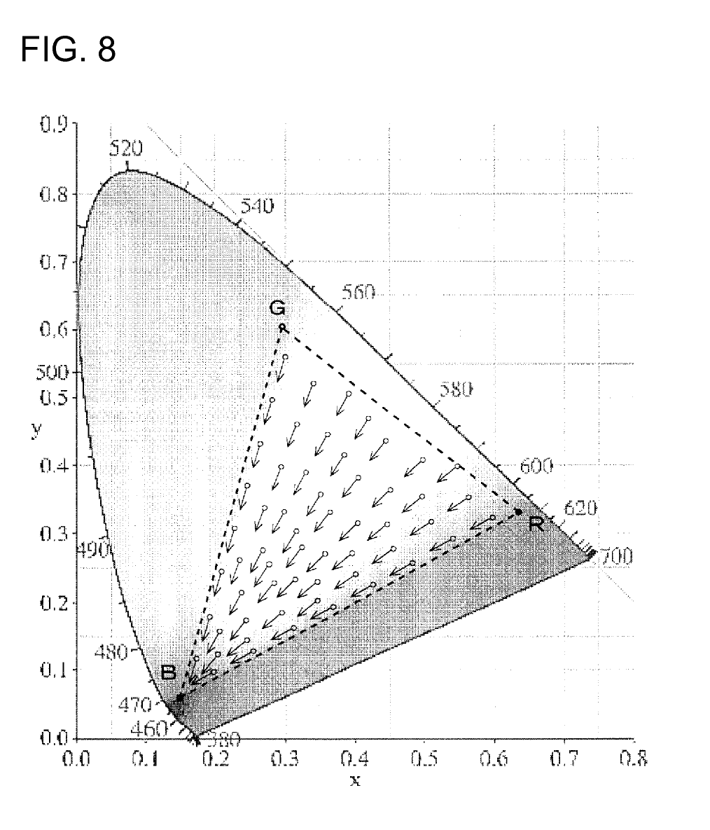

Display characteristics when the liquid crystal touch panel 20 develops a bluish tint will be described with reference to FIG. 8. FIG. 8 is an xy chromaticity diagram for describing these characteristics. FIG. 8 is the same as a normal xy chromaticity diagram, and the dotted triangle shows the range of color in sRGB (standard RGB): the upper left end corresponds to green (G), the lower left end corresponds to blue (B), and the right end corresponds to red (R). The arrows in FIG. 8 help show the bluish tint of the screen displayed by the liquid crystal touch panel 20 in the xyz color coordinate system.

As can be seen in FIG. 8, the respective display colors of the liquid crystal touch panel 20 shift towards blue, and this causes the user to feel that the display is unnatural, especially if the user is also viewing (or comparing) the display color of the 3D liquid crystal panel 10. As a countermeasure, rather than compensating for the chromaticity of the liquid crystal touch panel 20, the display color of the 3D liquid crystal panel 10 is corrected so as to shift to a blue color that is similar to the blue color of the liquid crystal touch panel 20, and thus this type of chromaticity shift of the liquid crystal touch panel 20 will feel natural to the user. Correcting the display color of the 3D liquid crystal panel 10 in this manner makes it possible to faithfully reproduce the characteristics described above, because display is possible at high gradation, as described above.

If a configuration is used whereby the display data signal received from outside and to be sent to the liquid crystal touch panel 20 is corrected in order to compensate for the display color of the liquid crystal touch panel 20, then there is a possibility that the user will find the display unnatural due to the correction not being accurate, because of the low gradation display. Furthermore, the liquid crystal touch panel 20 has touch panel-related circuits embedded in the pixel circuits, which makes it fundamentally difficult to adjust the display color. Accordingly, by correcting as described above, even if the bluish tint is compensated for, there is a risk that display quality will suffer as a whole, due to other changes such as color balance degradation. Thus, it is preferable that correction be performed for the 3D liquid crystal panel 10, rather than the liquid crystal touch panel 20. The present invention, however, is not limited to this configuration, and correction may be performed on the liquid crystal touch panel 20, or correction may be performed on both the 3D liquid crystal panel 10 and the liquid crystal touch panel 20.

### 4. EFFECTS

As described above, a portable terminal (display device 100) having two screens in the present embodiment changes the bluish tint of the 3D liquid crystal panel 10 screen through a settings screen or the like on the liquid crystal touch panel 20 for changing the bluish tint of the liquid crystal touch panel 20; therefore, is it not necessary to individually adjust both liquid crystal panels, and the tint of both liquid crystal panels can be matched with ease.

### 5. MODIFICATION EXAMPLE

In the embodiment described above, there is user input, as described in FIG. 7, but a configuration may be used whereby values corresponding to the input values are calculated automatically. During product manufacture, a factory, service center, or the like typically calculates the input values so that the tints become the same by connecting an imaging device such as a camera to the portable terminal in question and then capturing an image of the screen of the liquid crystal touch panel 20 and the 3D liquid crystal panel 10. The calculated input value is sent to the color correction table storage unit 22 and has a similar configuration to the embodiment described above.

A configuration may be used whereby a person who knows a prescribed hidden command or password at the service center or the like is able to use a user interface, such as that shown in FIG. 7, instead of the user performing color adjustments as described in the embodiment above. This would make it possible to prevent color correction errors by the user.

In the embodiment described above, an example was described in which the portable terminal has two screens: the liquid crystal touch panel 20 and the 3D liquid crystal panel 10. The configuration above, however, is not limited to this, because if there are a plurality of screens or a plurality of display panels, the differences in tints will be noticed by the user from screen to screen if the characteristics differ. In this case, if a configuration is used whereby the tint of one display panel is corrected to be the same or to approximate the tint of another display panel, then there is no need to perform correction such that all display panels become an ideal tint. In this regard, similar effects to the above can be achieved.

In the present embodiment, the data correction unit 23 uses the matrix parameters Mp stored in the color correction table storage unit 22 to correct the blue pixel values, but the matrix parameters Mp do not necessary need to be stored as tables in the color correction table storage unit 22, and a configuration may be used whereby the matrix parameters Mp are calculated instead. The data correction unit 23 may perform correction with parameters other than the matrix parameters Mp. Furthermore, the ultimate aim is for the pixel gradation values to be corrected, and thus a well-known gradation correction method such as correcting the gradation voltages, for example, may be adopted instead of the above-mentioned configuration.

In the above-mentioned embodiment, the liquid crystal display device was described as an example, and the display device is not limited to using liquid crystal, as long as the display device is a matrix display device. The display device may use electrooptical elements such as inorganic EL (electroluminescent) elements or organic EL elements instead of liquid crystal, for example. “Electrooptical elements” refers to all elements whose optical characteristics change when given electricity, such as field emission displays (FEDs), microelectromechnical systems (MEMs) displays, LEDs, charge driving elements, E-ink, and the like, in addition to EL elements.

### INDUSTRIAL APPLICABILITY

The present invention is applied to a display device that has two display panels, such as a portable terminal, in particular, and to a display device that can adjust the tint on the two display panels.

### DESCRIPTION OF REFERENCE CHARACTERS

10 first display device

11 3D liquid crystal panel

12 liquid crystal touch panel

20 second display device

21 timing control unit

22 color correction table storage unit

23 data correction unit

30 terminal controller

100 display device

200 display control circuit

300 image signal line driving circuit

400 scan signal line driving circuit

500 display unit

G (k) scan signal (k=1, 2, 3, . . . )

GL (k) scan signal line (k=1, 2, 3, . . . )

S (j) image signal (j=1, 2, 3, . . . )

SL (j) image signal line (j=1, 2, 3, . . . )

Mp matrix parameter

CT, CS control signal

1. A display device for displaying images on a first screen and a second screen, comprising:
a first display panel having the first screen to display an image thereon in accordance with a first image signal;
a second display panel having the second screen to display an image thereon in accordance with a second image signal; and
an image adjustment unit that adjusts a tint of the image to be displayed on the first screen by correcting pixel gradation values included in the first image signal in accordance with a color correction scheme that is prescribed such that a tint of a reference image displayed on the first screen matches a tint of said reference image displayed on the second screen, so that the tint of the first screen matches a tint of the second screen.

2. The display device according to claim 1, wherein the second display panel is a touch panel that can obtain coordinates from the second screen when adjacent to, in contact with, or pressed by a user.

3. The display device according to claim 2, wherein the second display panel is a resistive scheme or a capacitive scheme touch panel.

4. The display device according to claim 3, wherein the image adjustment unit performs correction to increase blue pixel gradation values among the pixel gradation values included in the first image signal.

5. The display device according to claim 1, wherein the first display panel is configured to display glasses-free stereoscopic images using a parallax barrier scheme or a lenticular lens scheme.

6. The display device according to claim 1, wherein the first display panel and the second display panel are provided in a position where the first screen and the second screen can be viewed at the same time by a user.

7. The display device according to claim 1, wherein the image adjustment unit adjusts the tint through matrix conversion.

8. A method of display for causing images to be displayed on a first screen and a second screen, the method comprising:
displaying an image on the first screen in accordance with a first image signal;
displaying an image on the second screen in accordance with a second image signal; and
adjusting a tint of the image to be displayed on the first screen by correcting pixel gradation values included in the first image signal in accordance with a color correction scheme that is prescribed such that a tint of a reference image displayed on the first screen matches a tint of said reference image displayed on the second screen, so that the tint of the first screen matches a tint of the second screen.
